(19) United States
(12) Patent Application Publication
(10) Pub. No.: US 2009/0144636 A1
(43) Pub. Date: Jun. 4, 2009

(54) Methods for the Creation of Multiple Email Messages from a Singular Email Message

(75) Inventors: Margaret A. Beynon, Southampton (GB); Sian S. January, Winchester (GB); David G. Screen, Winchester (GB)

Correspondence Address: Cantor Colburn LLP-IBM Europe, 20 Church Street, 22nd Floor, Hartford, CT, 06103, US

(73) Assignee: International Business Machines Corporation, Armonk, NY (US)

(21) Appl. No.: 11/949,507

(22) Filed: Dec. 3, 2007

(51) Int. Cl. G06F 3/01

(52) U.S. Cl. 715/752

(57) ABSTRACT

Exemplary embodiments of the present invention relate to a methodology for dividing a primary email message composition into multiple secondary email messages. As such, a graphic user interface (GUI) is provided with a plurality of message composition windows wherein a user may compose a primary email message and thereafter construct multiple amounts of desired secondary email messages.

### BACKGROUND OF THE INVENTION

1. Field of the Invention

This invention relates to email messaging applications, and particularly to methodologies for the segmenting of email messages into multiple messages.

2. Description of Background

When composing an email there may occur under varying circumstances the need to augment either a particularly long message or a reply to an existing extended chain of message. The need may especially occur in the event that there are a plurality of intended message recipients wherein each intended recipient may only need to have access to certain portions of the message. In this instance, instead of subjecting an intended recipient to the task of pursuing the entire length and subject matter of a message delivered to a group of individuals, the message should be tailored to deliverer the relevant aspects of the message to each individual.

### SUMMARY OF THE INVENTION

The shortcomings of the prior art are overcome and additional advantages are provided through the provision of a method for the separation of an email message into a plurality of discrete email messages. The method comprises displaying a GUI at a display device, wherein the GUI serves as an interface for an email client application, composing a primary email message in a primary email message text-editing window that is displayed within the GUI, identifying discrete paragraph sections within the primary email message, and associating a section identifier tag with each identified paragraph section within the primary email message.

The method also comprises displaying each section identifier tag in proximity with the paragraph section with which the section identifier tag is associated, determining a number of desired secondary email messages that will be composed, displaying within the GUI a secondary email message text-editing window for each determined secondary email message that is to be composed, and composing a secondary email message, wherein a secondary email message is composed by selecting a section identifier tag that is displayed within the primary email text-editing window and dragging the section identifier tag into the secondary email text-editing window, thereafter, the section identifier tag and the paragraph section that is associated with the section identifier tag are displayed within the secondary email text-editing window.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an outgoing email message composed in accordance with exemplary embodiments of the present invention.

FIG. 2 illustrates one example of a segmented outgoing message comprising paragraph section identification tags composed in accordance with exemplary embodiments of the present invention.

FIG. 3 illustrates one example of a primary message and secondary messages created from the primary message in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Aspects of the exemplary embodiment of the present invention can be implemented within a conventional computing system environment comprising hardware and software elements. Specifically, the methodologies of the present invention can be implemented to program a conventional computer system in order to accomplish the prescribed tasks of the present invention as described below.

Exemplary embodiments of the present invention relate to a methodology for dividing a primary email message composition into multiple secondary email messages. As such, a graphic user interface (GUI) is provided in conjunction with a client email messaging application that is executed either locally or remotely accessed by a user. The GUI comprises a plurality of message composition windows and operational function interfaces controls wherein a user may compose a primary email message and thereafter construct multiple amounts of desired secondary email messages.

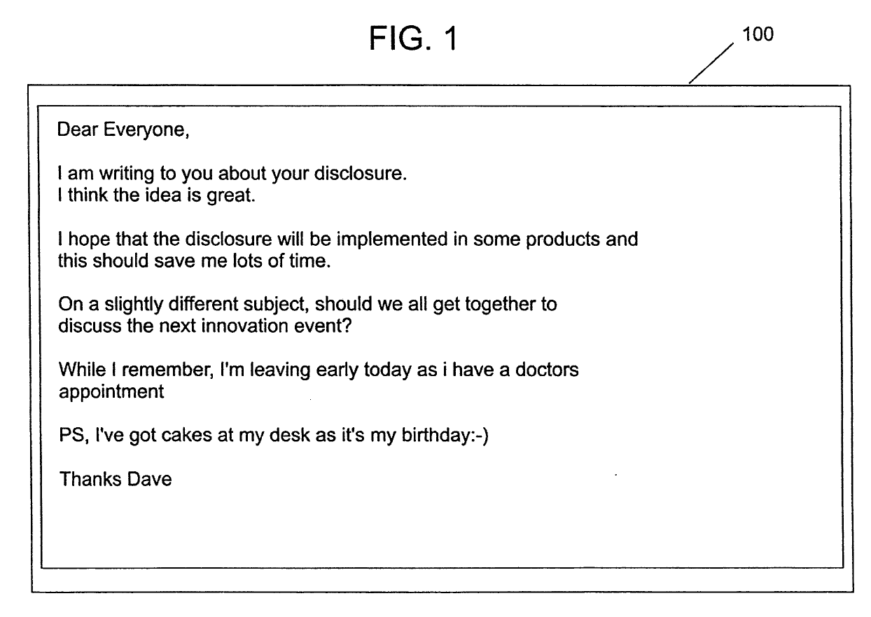

Turning now to the drawings in greater detail, it will be seen that in FIG. 1 there is GUI window 100 displaying a message that has been composed by a user. Upon the completion of composing the message, the user is presented with the option of either transmitting the message as is to any specified recipients or creating a plurality of secondary messages that are custom created for a specific recipient from the content of the primary email message. Within exemplary embodiments of the present invention, the GUI is configured to display a control interface for the automatic segmenting of a primary message in to discrete paragraph sections. A message may be segmented by the physical lay out of the composed message (i.e., according to the user composed paragraph placement), by know composition structure (i.e., according to collapsible sections marker, or header/footer placement within a composition), or by the identification of predetermined keywords or key phrases within the composed message.

As such, a keyword or key phrase analysis component can be provided to analyze a message composition in order to discover any words or topic phrases that could be used to segment a message composition. Further, a user can also configure the keyword/key phrase analyzing component to recognize specific keywords/key phrases that may be utilized to signify specific topics within a message or a change in topics within a message (e.g., such as “on another topic,” “PS,” “by the way,” etc.) that can be used to automatically segment a message composition. In further exemplary embodiments a word-based analysis can be performed to segment a message composition by the performance of a comparison of user specified significant words or phrases in neighboring lines or paragraphs and using a similarity value in order to determine whether or not to segment the message at the location of the identified word or phrase.

Once a message has been segmented into paragraph sections, the segmented message is displayed to the user. Thereafter, the user is presented with the option of manually reconfiguring the automatic paragraph section selections that have been implemented. Once the configuration of the paragraph sections has been approved by the user, the paragraph sections are manually tagged by the user with a paragraph section identifier tag. The paragraph section identifier tag serve the purpose of not only identifying a specific paragraph section, but are can be utilized to create secondary email messages as described below.

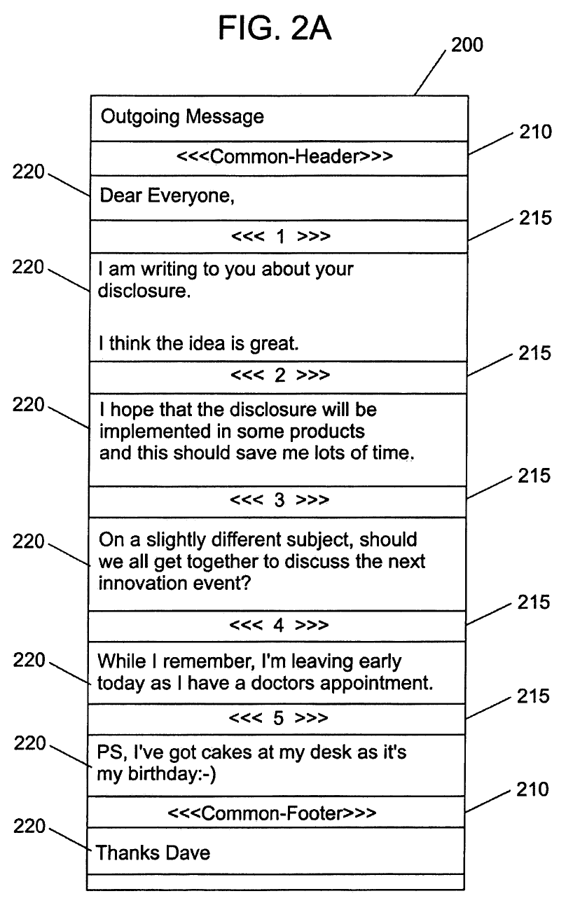

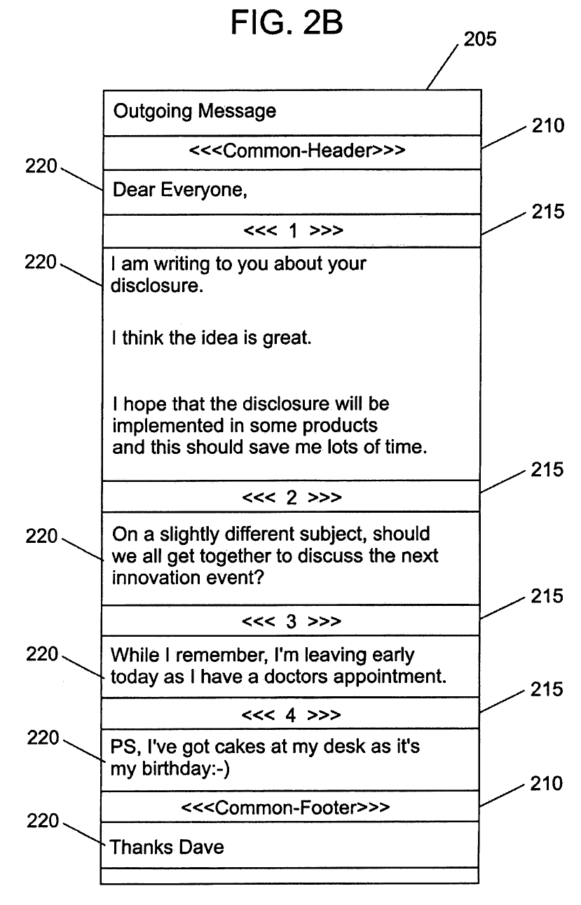

By default, the first paragraph of a message composition and the last paragraph of the message composition are automatically tagged as “Common-Header” and “Common-Footer,” respectively. The additional paragraph section identifier tags are supplied and entered by the user. FIG. 2A shows a segmented outgoing message 200. The segmented message 200 comprises a plurality of paragraph section identifier tag fields of a “common” type 210 and user specified type 215. The paragraph section fields 220 that are associated with each respective paragraph section identifier tag are shown positioned beneath there respective identifier tags 210, 215. The paragraph section identifier tags 215 are shown as comprising consecutive sequenced numbers, however, the paragraph section identifier tags can comprise any name or nomenclature that the user desires. A user may also manually specify that a paragraph section identifier tag as a common type tag if she so desires.

As shown in FIG. 2B, once tagged with an identifier 215, the user further edit the paragraph selections 220. As shown, the user manually selected text portions from paragraph section identifier tag <<<2>>> and deposited the text portion under <<<1 >>>, thereby associated the text portion with paragraph section identifier tag <<1>>>. Within further exemplary embodiments this operation can automatically be accomplished by the user selecting (highlighting) the desired text that is to be combined and executing a “combine” control displayed at the GUI, whereas the text is combined under a desired paragraph section identifier tag 215.

Once all of the segmented text has been associated with a paragraph section identifier tag, the user is presented with the option of creating a predetermined number of secondary email messages either manually or automatically. Within the manual secondary GUI window configuration, once prompted the user enters the number of messages that she desires to create. Upon entering the amount, secondary GUI text-editing windows are displayed to the user. Within the automatic secondary GUI window configuration, secondary email windows are automatically generated in the event that the user has used consecutively sequenced numbers as paragraph section identifier tags 215. In this instance, a secondary email message is automatically generated wherein each message contains the text portion 220 of the message segment that is associated with a respective numbered paragraph section identifier tag 215.

Within exemplary embodiments of the present invention all common type paragraph section identifier tags 210 and the message text portion that is associated with the paragraph section identifier tag 210 are automatically copied into all created secondary email message text-editing GUI windows. The secondary messages can be further composed by selecting and dragging any desired paragraph section identifier tag 215 or paragraph section text portion 220 into the secondary message text-editing window. If a section identifier tag 215 is dragged in to a secondary text-editing window then the paragraph section 220 that is associated with the paragraph section identifier tag automatically is copied into the secondary text-editing window, the opposite being true in the even that the paragraph section 220 text portion is dragged in to the secondary text-editing window. Within further exemplary embodiments, by default secondary messages inherit the subject title of the primary message, however, these inherited text segments can also be edited in the GUI after the secondary windows have been created.

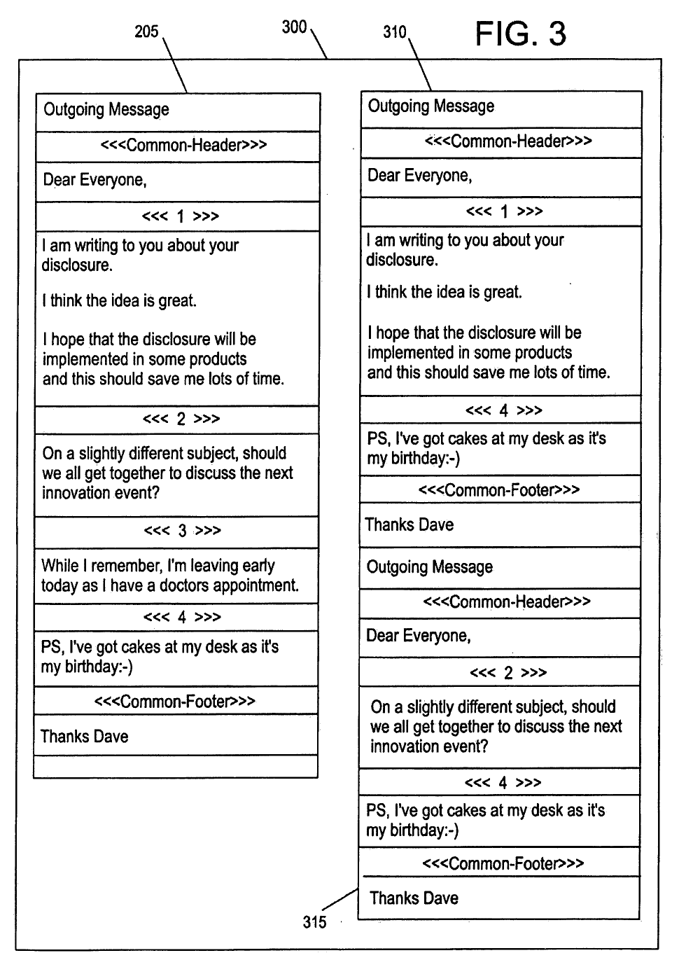

FIG. 3 shows an example of a primary message text-editing window 205 and a pair of secondary message text-editing windows 310 and 315. As shown, the primary message composition 205 is displayed in conjunction with the two secondary message composition windows 310 and 315. Both secondary message within the secondary windows 310 and 315 comprise the common type paragraph section identifier tags <Common-Header >>> and <<<Common-Footer >>>. As shown, the secondary message 310 further comprises the paragraph section identifier tags <<<1>>> and <<<4>>> and the text sections that are respectively associated with the paragraph section identifier tags, and the secondary message 315 further comprises the paragraph section identifier tags <<<2>>> and <<<4>>> and the text sections that are respectively associated with these paragraph section identifier tags.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1-5. (canceled)

6. A computer system having a GUI, the system for the separation of an email message into a plurality of discrete email messages, the system comprising:
a processor configured for:
displaying the GUI at a display device, wherein the GUI serves as an interface for an email client application;
composing a primary email message in a primary email message text-editing window that is displayed within the GUI;
identifying discrete paragraph sections within the primary email message;
associating a section identifier tag with each identified paragraph section within the primary email message;
displaying each section identifier tag in proximity with the paragraph section with which the section identifier tag is associated;
determining a number of desired secondary email messages that will be composed;
displaying within the GUI a secondary email message text-editing window for each determined secondary email message that is to be composed; and
composing a secondary email message, wherein a secondary email message is composed by selecting a section identifier tag that is displayed within the primary email text-editing window and dragging the section identifier tag into the secondary email text-editing window, thereafter, the section identifier tag and the paragraph section that is associated with the section identifier tag are displayed within the secondary email text-editing window.

7. The computer system of claim 6, wherein a primary email message can be edited by associating at least two paragraph sections with the same section tag identifier.

8. The computer system of claim 7, wherein a section identifier tag can be categorized as a common-type section identifier tag, where in the event that a section identifier tag is categorized as a common-type section identifier tag, the section identifier tag and the paragraph section that is associated with the common-type section identifier tag are displayed within each displayed secondary email text-editing window.

9. The computer system of claim 8, wherein a secondary email message window is displayed for each section identifier tag and the paragraph section that is associated with the section identifier tag for each section identifier tag that is not a common-type section identifier tag.

10. The computer system of claim 9, wherein discrete paragraph sections are identified by analyzing the primary email message in order to identify predetermined keywords or key phrases within the primary email message, where in the event that a keyword or key phrase is identified the keyword or key phrase serves as an indicator of the start of a discrete paragraph section.
